(19) United States
(12) Patent Application Publication
(10) Pub. No.: US 2005/0046817 A1
(43) Pub. Date: Mar. 3, 2005

(54) Content preservation

(75) Inventors: Gene J. Wolfe, Pittsford, NY (US); Seth A. Borg, Rochester, NY (US)

Correspondence Address: MILES & STOCKBRIDGE PC, 1751 PINNACLE DRIVE, SUITE 500, MCLEAN, VA, 22102-3833, US

(73) Assignee: Communication Synergy Technologies, Rochester, NY (US)

(21) Appl. No.: 10/925,953

(22) Filed: Aug. 26, 2004

Related U.S. Application Data
(60) Provisional application No. 60/497,559, filed on Aug. 26, 2003.

(51) Int. Cl. G03B 27/44

(52) U.S. Cl. 355/54

(57) ABSTRACT

A long-term solution for document and information storage is based on the storage of an image of the actual document, rather than on binary coding. Associated with the storing of this image are readers and writers that allow reading/writing in numerous formats as well as the supplementing of the stored image with other data such as digital data, bar code(s), metadata, retrieval information, and the like. This human readable format has the capability of removing the need for interpreting devices, hardware and/or software for retrieval of the stored image(s).

### RELATED APPLICATION DATA

This application claims the benefit of and priority under 35 U.S.C. §119(e) to U.S. Patent Application No. 60/497,559, filed Aug. 26, 2003, entitled “Preservation Media System,” which is incorporated herein by reference in its entirety.

### BACKGROUND

1. Field of the Invention

This invention generally relates to content storage. In particular, an exemplary aspect of this invention relates to a preservation modality for data storage and archival media.

2. Description of Related Art

The preservation of information is necessary to ensure that software, hardware and/or content in general is not rendered useless or lost. Preservation generally includes the long-term storage of information in the form of images, records, data, documents, and the like. Many organizations actively promote the use of conventional preservation systems such as microfilm, microfiche and aperture cards for content preservation. These are most commonly used to provide long-term assurance of information storage.

The conventional compact disc (CD) is a nonmagnetic disc used for audio or video recording or for data storage. Information is recorded using a laser beam to burn the microscopic pits into the surface of the disc with the information being accessed by means of a low-power laser to sense the presence or absence of the pits.

With a CD-R disc, the color of the CD-R disc varies depending on the type of dye used in the recording layer. A laser is then used to write to the recording layer of the dye resulting in optical interference changes that form pitted and unpitted areas.

For CD-RW discs, the recording portion of the CD-RW disc supports phase changes. Phase change material changes from an amorphous state to a crystalline state, or phase-through exposure to variably-powered laser beams. When written to by a high-power laser beam, the material changes to an amorphous (recorded) phase, and with a medium-powered laser beam, the material forms into the crystalline (erased) phase.

In general, optical dye-based media include four layers: a substrate, a phase change dye layer, a reflective layer and an overcoat or protective layer. The substrate is generally made of a polycarbonate layer that includes lands and valleys that are currently approximately one micron apart. The phase change dye layer is typically an AZO polymer (with a visible blue hue) that is opaque in infrared or near infrared light. Exposure to coherent light changes its optical incidence of reflection angle. This phase-change dye is typically vacuum spun coated on the substrate.

Another dye, cyanine, is the original dye polymer used in specifications for recordable media. Discs using this type of dye typically have a green hue. During writing, the chemical composition of the dye is altered thereby altering the transmissibility of the dye. With another dye, phthalocyanine, during the writing stage heat from the laser causes the dye to melt, and as the dye melts, the polycarbonate layer below the dye expands to fill a gap. This melted portion of the “blob” diffuses the light sufficiently to resemble pits.

A reflective layer is typically a metal or a metalloid polymer that is reflective to light. This can be applied through, for example, a vapor deposition technique and is generally very thin. The protective layer is a simple polymer layer that acts as an overcoat.

### SUMMARY

Our everyday lives are built upon a technology infrastructure that has evolved over many generations. Civilizations can be benchmarked by their contributions to science and technology, but only those contributions that withstand the test of time can be capitalized upon. Therefore, societies' ability to record and document contributions to science is as important as the actual scientific innovations themselves.

Today we rely on the explosion of information that documents our advancing world culture. But within a single generation we have seen information lost forever due to the technical obsolescence of storage media used. There is a genuine concern for where we would be if we were unable to preserve knowledge that forms the platform of our daily and future lives.

Unfortunately, the nature of today's storage method, a digital file, makes the file subject to alteration or corruption. Alteration can potentially invalidate the document or make it no longer accurate. Corruption can render the document unavailable and lost forever if, for example, it was the only copy.

Increasingly, legislation is directed toward effective record management. Sarbanes-Oxley, HIPAA, CFR Part 11, DoD5015.2, Check 21, as well as many more are just a few examples of the governments' influence on records management. An exemplary aspect of the invention provides safe storage for critical content, such as documents and images in a format that can be both unalterable and irrefutable. Applications include, but are in no manner limited to, government records, birth and death records, marriage licenses, criminal records, SEC filings, financial records, insurance policies, medical records, nuclear power plant logs, e-mail messages, deeds, mortgages, student records, credentials, titles, books, genealogical information, records, video content, or in general any content, electronic or paper based, including any content currently stored on film, paper, and/or in a digital format is capable of being stored by the system.

An exemplary aspect of the invention provides a long-term solution for document and information storage. The exemplary system is based on the storage of an image of the actual document, rather than on binary coding. This human readable format can remove the need for interpreting devices, hardware and/or software, and transcends likely future changes in data coding.

Preservation information in the commercial world has not been addressed adequately. Preservation is extremely difficult, both mentally and physically. Mentally, it is difficult to convince people to take the long-term view, especially in today's faster, better, cheaper society. Society rarely acts with an eye towards the future, with preservation at best being an afterthought. For this reason, preservation is generally viewed as passe or not notably important or fruitful for development.

Physically, the tools for easy, quick and cost-effective preservation do not now exist. Current practices and formats for preserving digital information, while quick and easy, demand fully functioning hardware and software that may not be available in the future of in the aftermath of a catastrophic war or a large-scale disaster. Preservation of original digital information in solely digital format is insufficient. What is needed is storage in a single, universal format that will not change as long as human perception and interpretation remains, as well as one that can outlast current data writing formats.

Most standards for records management and document archives of legal and/or historic documents require that they be preserved in their original appearance. This means that in the absence of a physical document, an irrefutably accurate image of the content must be made. Historically, microfilm has satisfied requirements for human readable information storage. However, microfilm technology is slow and cumbersome. Furthermore, these methods suffer from slow retrieval rates, expense, costly equipment used to write to the film, expense and labor for processing the film, and the fact that specialized equipment is required to retrieve information from the film.

Digital systems are fast, reliable, and support multiple file formats, but they do not provide a human readable file in its stored state. The file must first be interpreted by a digital system of hardware and software for display on a monitor or for printing to be human readable. Furthermore, as discussed earlier, the digital storage methodology makes the file subject to alteration or corruption. A central requirement for a preservation media to be recognized as a legal form of documentation is that it is unalterable after it is created and developed. With microfilm, once the silver is washed away and the media fixed, it is no longer optically active. Digital storage modalities are not fundamentally unalterable. At anytime, they can be transitioned from one state to another, i.e., a hard drive cannot be set to a permanent “read only” state.

Accordingly, microfilm remains the media of choice for records management and archiving. Yet the film itself, film processing, film storage and retrieval of microfilm images are costly and cumbersome and time consuming.

Manufactures have followed a path to store more data more quickly in a digital format. The progression can be shown from CD's to faster CD's to CD-R's to DVD's to multi-layer DVD's, to blue ray DVD's, and so on. Information can be stored digitally for preservation purposes, but there is concern that the current media and media systems will not support preservation in the long run. Conventional mechanisms for writing to a CD-R or DVD-R for the storage and retrieval of digital information use a laser which burns pits of length 0.001 mm to 0.002 mm into groves on an optical storage media. A pattern of strictly regulated marks is formed in Eight to Fourteen Modulation (EFM) that can later be retrieved, but has no apparent organization to the human eye. The nature of the EFM pattern serves several purposes including error recovery and calibration, and of course it represents the digital data itself. This format is inherent to the format of a CD or DVD and without this pattern, a computer assumes that the storage media has a critical defect or is empty.

An exemplary aspect of this invention writes patterns corresponding to portions, such as pixels, of the original image. The portions can continue to be “digitally” read as in conventional CD readers, but archivists will also be able to view them optically after magnification to reform the original image with either reflected or transmitted light. There are various ways to write portions that correspond to the original image. Lengths of patterns can be varied by increasing exposure time as a beam, such as a laser or other collimated light emitting device, scans across the storage media. An increased exposure time can lead to improved contrast. Furthermore, altering the power level of the laser can allow the ability to ablate a deeper or broader pattern that can result in, for example, grayscale and/or color capabilities.

An image processing and dithering technique can also be combined with the patterning to yield, for example, a multi-level grayscale. Furthermore, a combination of multiple pieces of media and/or a number of filters can be used to save/recover a full cover image. This image could be recovered in many different ways including using, for example, a recombining and projection technique.

Another exemplary embodiment of the system uses a “write-once” dye such as that found in conventional CDR and DVDR media. By writing two identical images, a positive image and an associated negative image of the same information, the content can be made tamper-proof. The positive image prevents anything from being erased in that the media cannot be “un-burnt.” Information can also not be added to the positive image without it being detectable by the negative image in that the negative image was already blacked out in those areas and cannot be “un-burnt.” For example, if information were subsequently added to the positive image, for example, in an effort to alter the image, the negative image would also need to be affected but inversely to maintain consistency. However, since the media are write-once, and the negative image would already contain information in the altered area, the superimposition of the two image would show the alterations. Conversely, no information could be removed from the negative without the positive showing a discrepancy. Hence, if nothing can be removed or added, media itself will reflect any tampering attempts. Even if the original data were to be destroyed, the area where the destruction occurred would be detectable since both the positive and the negative image would have burnt pixels at the same location(s).

Serial number(s), watermarks, bar coding, and the like, as well as digital information, can be added to the media. For example, watermarking can be used in conjunction with grayscale imaging thus allowing a “ghost” image to be written, for example, beneath the protected image to ensure that it can be verified and has not been tampered with or counterfeited. Serial numbers and bar coding can be used, for example to aid in the classification and rapid retrieval of the media from a media storage location(s).

Additional aspects of the invention relate to the media itself. The media could be designed to last for centuries, as opposed to decades. To accomplish this, the properties of the media must itself be chemically and mechanically stable as well as tolerant to, for example, long-term electromagnetic radiation, chemical oxidation or reduction reactions, humidity, temperature fluctuations, radioactive radiation, cosmic radiation, and must be mechanically tolerant to deformation, handling, vibration, stress, and the like, for example, in accordance with use and storage. Furthermore, since the media will remain readable by the human eye, a higher bit rate error can be tolerated.

Existing CD technology uses a single groove, or track, that contains pits and unpitted areas representative of digital data. Preservation images according to an embodiment of this invention can written into existing CD grooved discs, and the preservation images written into pixels stored in that single groove, i.e., valley. The groove is, however, separated by a land. The preservation images may subsequently be stretched or periodically broken-up as the “land” between the valleys has a finite width. An exemplary aspect of the invention allows the preservation image to be written in such as way that the image is still human readable despite the lands. Thus, the image could be “stretched.” The image could then be “un-stretched” by optical means and/or software or hardware during data recovery from the media and will still remaining human readable at a lower resolution, for example, upon magnification. A land-groove approach can also be utilized through re-addressing in a subsequent higher resolution, higher density version of the media where the grooves on the lower substrate of the CD/DVD could be removed.

During the writing process, the valleys/lands could alternatively be ignored and imaging information could be written to both areas, producing a natural, undistorted image.

In addition to the various types of media discussed above, various types of readers and writers are discussed herein that can be used in conjunction with the various types of media. Additionally, various types of other data such as digital data, table of contents information, media identification/classification information, and the like can also be stored on the various media discussed herein.

In addition to be utilized as a stand-alone system, is should be appreciated that the systems and methodology used herein could be used in conjunction with, for example, the Preservation System disclosed in U.S. patent application Ser. No. 10/625,692, filed Jul. 24, 2003, which is incorporated herein by reference in it entirety.

These and other aspects of the invention will be or are apparent from the following detailed discussion of the embodiments.

### BRIEF DESCRIPTION OF THE DRAWINGS

FIG. 1 is an exemplary embodiment of a preservation media according to this invention;

FIG. 2 is an enlarged partial view of an exemplary media according to this invention;

FIG. 3 is an enlarged partial view of an exemplary media according to this invention;

FIG. 4 is an enlarged partial view of an exemplary media according to this invention;

FIG. 5 is an enlarged partial view of an exemplary media according to this invention;

FIG. 6 is an enlarged partial view of an exemplary media according to this invention;

FIG. 7 is an enlarged partial view of an exemplary media according to this invention;

FIG. 8 is an enlarged partial view of an exemplary media according to this invention;

FIG. 9 is an exemplary stacked media according to this invention;

FIG. 10 illustrates an exemplary embodiment of the stacked media according to this invention;

FIG. 11 illustrates an exemplary transmissive media according to this invention;

FIG. 12 illustrates an exemplary reflective media according to this invention;

FIG. 13 illustrates exemplary media associated with color content according to this invention;

FIG. 14 illustrates an exemplary color media according to this invention;

FIG. 15 illustrates a second exemplary color media according to this invention;

FIG. 16 illustrates a third exemplary color media according to this invention;

FIG. 17 illustrates an exemplary dithering technique according to this invention;

FIG. 18 illustrates an exemplary square media according to this invention;

FIG. 19 illustrates an exemplary method of arranging the preservation images according to this invention;

FIG. 20 illustrates a second exemplary embodiment of arranging the preservation images according to this invention;

FIG. 21 illustrates a third exemplary embodiment of arranging the preservation images according to this invention;

FIG. 22 illustrates an Eight to Fourteen pattern;

FIG. 23 illustrates an exemplary preservation image according to this invention;

FIG. 24 illustrates an exemplary method of swath writing according to this invention;

FIG. 25 illustrates exemplary writing patterns according to this invention;

FIG. 26 is an exemplary writer/reader system according to this invention;

FIG. 27 is an exemplary grayscale media according to this invention;

FIG. 28 illustrates the relationship between bit depth and laser power according to an exemplary embodiment of this invention;

FIG. 29 is a first exemplary reader system according to this invention;

FIG. 30 is a second exemplary reader system according to this invention;

FIG. 31 is a third exemplary reader system according to this invention;

FIG. 32 is a fourth exemplary image reader system according to this invention;

FIG. 33 is an exemplary color reader system according to this invention;

FIG. 34 is an exemplary animation reading system according to this invention;

FIG. 35 illustrates an exemplary animation filter disc according to this invention;

FIG. 36 illustrates an exemplary protection technique according to this invention;

FIG. 37 illustrates a second exemplary protection technique according to this invention;

FIG. 38 illustrates an exemplary method of preparing a negative image according to this invention;

FIG. 39 illustrates exemplary methods of marking preservation media according to this invention;

FIG. 40 illustrates an exemplary encryption technique according to this invention; and

FIG. 41 is an exemplary method of preparing preservation media according to this invention.

### DETAILED DESCRIPTION

The exemplary embodiments of the invention will be described in relation to preservation media as well as associated reading and writing systems and associated encryption, data protection and marking techniques. However, it should be appreciated, that in general, the systems and method of this invention would work equally well with any type of media and accompanying readers and/or writers utilizing the techniques discussed herein.

The exemplary systems and methods of this invention will be described in relation to specific media, readers and writers and associated hardware and software. However, to avoid unnecessarily obscuring the present invention, the following description omits well-known structures and devices that may be shown in block diagram form or otherwise summarized.

For purposes of explanation, numerous details are set forth in order to provide a thorough understanding of the present invention. It should be appreciated however that the present invention may be practiced in a variety of ways beyond the specific details as set forth herein. For example, the systems and methods of this invention can generally be applied to any type of media using the writing techniques disclosed herein, and is not limited to the specific type of preservation media disclosed herein.

Furthermore, while the exemplary embodiments illustrated herein show the various components of the system collocated, it is to be appreciated that the various components of the system can be located at distant portions of a distributed network, such as a telecommunications network and/or the Internet, or within a dedicated secure, unsecured and/or encrypted system. Thus, it should be appreciated that the components of the system can be combined into one or more devices, such as a reader/writer, or collocated on a particular node of a distributed network, such as telecommunications or computer network. As will be appreciated from the following description, and for reasons of computational efficiency, the components of the system can be arranged at any location within a distributed network or hardware system without affective the operation of the system.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software or combination of hardware and software that is capable of performing the functionality associated with that element.

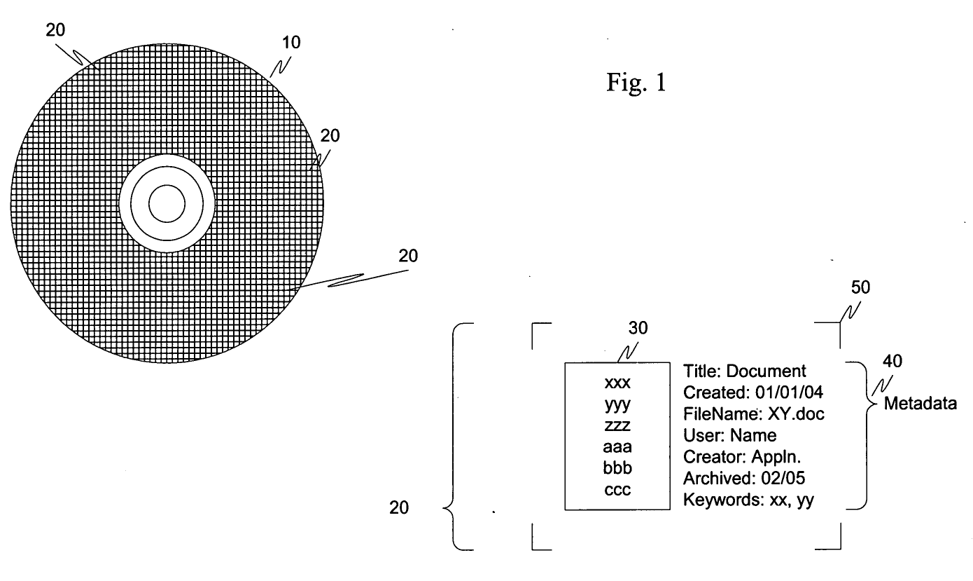

FIG. 1 illustrates an exemplary preservation media 10 according to this invention. As previously discussed, human-readable information is stored on the substrate of the media 10. This human readable information can include representations of content 20, such as documents 30, as well as metadata 40 associated with the content such as the title, creation date, and the like. Furthermore, one or more calibration/alignment marks 50 can be associated with the content 20 to facilitate, for example, machine reading.

In addition to being able to use conventional media, such as CD's, CDR's, CDRW's, DVD's, DVDR's, DVDRW's, MD's, and the like, discussed hereinafter are modifications and alternatives to media that can be used in conjunction with the preservation system.

In accordance with an exemplary embodiment of the preservation system, the normal EFM pattern is replaced by a pattern representing an image. The images are then arranged fir fitment on the preservation media as illustrated in exemplary embodiments disclosed herein. The pattern representing the image corresponding to the original content can then be generated by, for example, converting a rectilinear data stream, which is similar to that used for writing digital data to a conventional CD, into a polar data stream that is written on the preservation media.

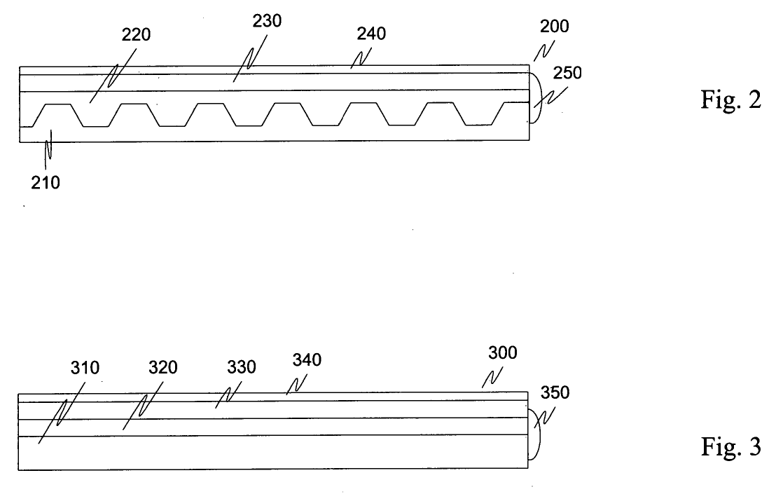

FIG. 2 illustrates a preservation media 200 that includes a polycarbonate substrate 210, a phase change dye layer 220, a reflective layer 230 and a protective overcoat 240. The preservation media 200 also includes a sealed edge portion 250 that seals the phase change dye layer to prevent, for example, humidity, other environmental elements and/or contaminants from entering and degrading the performance or integrity of the media. The sealed edge portion 250 could be applied by, for example, rotating the edge of the preservation media 200 through a path of sealant. However, it should be appreciated that any method of sealing the edge of the media will work equally well with the systems and methods of this invention.

The sealed edge portion could be comprised of the same material as the polycarbonate substrate. A high temperature application could be utilized where a localized melting effect would ensure a good seal. As pictured, the sealed edge portion 250 is contacting the substrate 210, dye 220 and reflective layer 230. However, the edge seal portions discussed herein can be expanded or contracted to include more or less layers than that illustrated.

Prior to application of the sealed edge portion 250, the edge of the preservation media 200 could be made rough by application of any abrasive material to, for example, increase surface area bonding and strength. Glass, Lucite, epoxy, and the like, are all additional edge sealant material options.

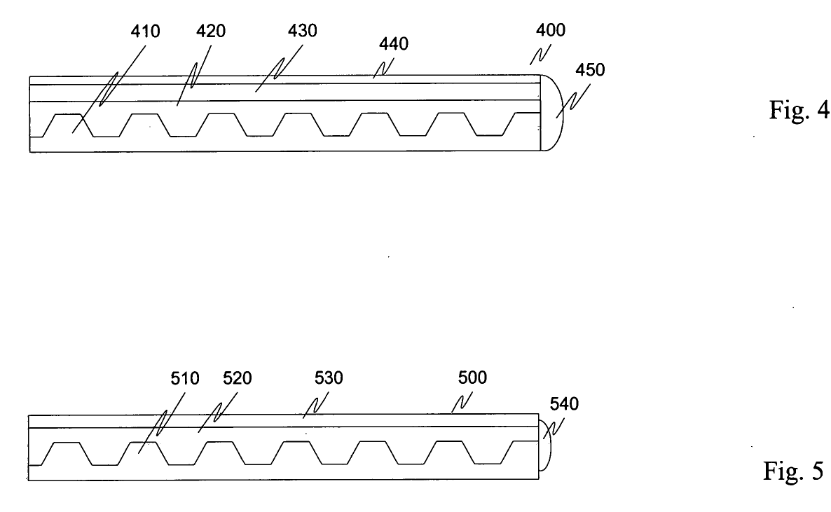

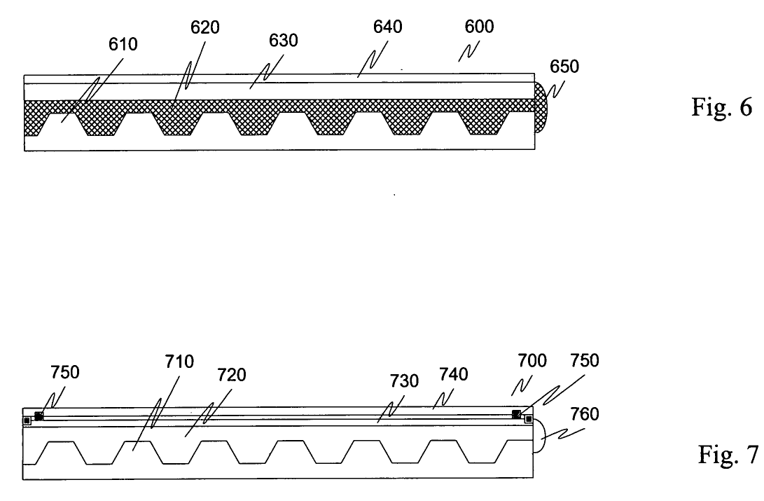

FIG. 3 illustrates a preservation media 300 with a four-layer process with the lower substrate 310 not having grooves (lands and valleys). The elimination of grooves in the lower substrate removes the “Venation blind” image artifacts that can appear optically in the viewable image. Moiré patterning can also be reduced by the elimination of the grooves. The media 300 of FIG. 3 includes a polycarbonate substrate 310, for example, with a unique uniform plainer surface, a phase change dye layer 320, a reflective layer 330 and a protective overcoat 340. Additionally, the media 300 can further include a sealed edge 350 similar to that illustrated in FIG. 2 or 4. For example, and in addition to or in combination with the above, the sealed edge portions can be dried dye, a plastic, or the like, that encapsulates, for example, the phase change dye layer.

FIG. 4 illustrates another exemplary embodiment of a preservation media 400 also having a polycarbonate substrate 410, a phase change dye layer 420, a reflective layer 430 and protective overcoat 440. The preservation media 400 further includes an improved edge seal portion 450 that at least seals the phase change dye layer 420 and the reflective layer 430 as well as the substrate and the overcoat to, for example, prevent oxidation, contamination and/or degradation.

FIG. 5 is another exemplary preservation media 500 that includes a polycarbonate substrate 510, a phase change dye layer 520 and a protective overcoat 530. In this embodiment, the reflective layer has been removed thus allowing, for example, improved contrast and better transmission of light through the media. As with the other embodiments, the media 500 can also have an edge seal portion 540 that can seal one or more layers of the preservation media 500.

Preservation media 600 includes a polycarbonate substrate 610, an improved phase change dye layer 620, a reflective layer 630 and a protective overcoat 640, as well as a edge seal portion 650. The improved phase change dye layer 620 utilizes a dye that is higher in contrast in the visible spectrum than conventional dyes. Additionally, the dye may exhibit a more stable response over longer periods of time. The improved dye could be optically sensitive in the same region as the conventional dyes but exhibit a contrast change in the visible spectrum higher than that of cyanno, or like dyes. A modified AZO dye doped with a halogen could also be utilized.

FIG. 7 illustrates another exemplary preservation media 700. Media 700 includes a polycarbonate substrate 710, a phase change dye layer 720, a protective overcoat 730 and a removable reflective layer 740. The removable reflective layer 740 may be connected, for example, by the latching mechanisms 750, may peel off as a sticker, or may be otherwise fixably attached to the media 700. Other exemplary methods of attaching the reflective layer 740 to the media 700 include “static cling” attachment, mechanical fasteners, or the like. It should also be appreciated that the arrangement of layers may not be as explicitly illustrated in FIG. 7. Rather, the protective overcoat layer 730 instead of, or in addition, to being located on the phase change dye layer 720, could also be located on the upper surface of the removable reflective layer 740.

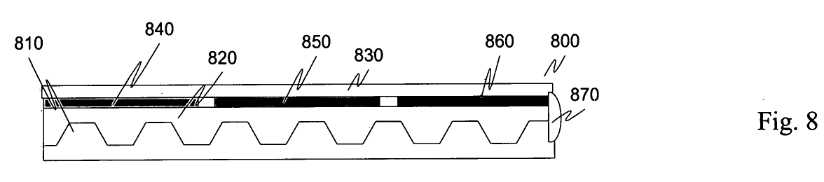

FIG. 8 illustrates another exemplary embodiment that can be used in conjunction with, for example, preservation of color images as discussed hereinafter. The color media 800 includes a polycarbonate substrate 810, a phase change dye layer 820, a protective overcoat layer 830, and one or more reflective colored layers, such as reflective red layer 840, reflective green layer 850 and reflective blue layer 860. Furthermore, as with the other embodiments, the media can include an edge seal portion 870 that can seal one or more layers of the media 800. It should be appreciated that the reflective color layers need not all be included on the same media, nor be red, green and blue. Rather, different color layers can be separated onto, for example, three different discs, with each media having a dedicated single color reflective layer. Furthermore, the color layers can be separated based on other color channels such as, CYMK, on image densities, code values for grayscale, transmissive or reflective media, or the like.

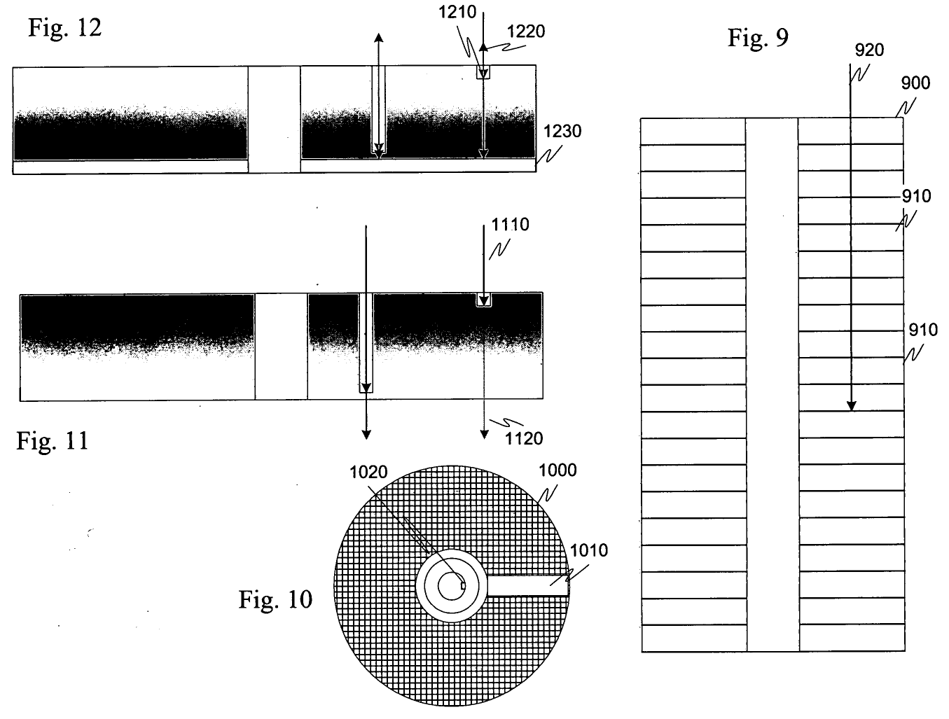

FIG. 9 illustrates another exemplary media that includes a plurality of dye and polycarbonate layers 910. In this exemplary embodiment, the preservation images could be generated and stored on separate and distinct layers within the media 900. For example, the media 900 could be constructed, e.g., stacked, such that the layers include a substrate, dye layer, polycarbonate layer, dye layer, polycarbonate layer, dye layer, . . . and an overcoat. As with the other embodiments, the media 900 could also include an edge seal portion (not shown). Furthermore, instead of a clear polycarbonate separation between each layer, a dye or filter could be employed as a separator. This could allow, for example, color or grayscale images to be produced with the layers including a substrate, dye layer, filter layer, dye layer, filter layer, dye layer . . . and an overcoat. This could allow color and/or grayscale images to be produced.

As illustrated in FIG. 10, the media 1000 could include a window 1010 such that if the media were stacked, as illustrated in FIG. 9, the individual media 1000 could be rotated within the stack such that the window 1010 displays information on the underlying media. Through the use of, for example, the key 1020, a spindle (not shown) could rotate one or more of the individual media within the media stack to thereby allow access by a reader/writer to any layer within the cylindrical media.

An additional enhancement could include altering the formulation of the phase change layers and/or increasing the power of the laser assembly to increase the contrast ratio or dynamic range in the visible spectrum by making dark or burnt pixels darker, while unaltered areas are more transmissive or reflective of incident light. Formulation change examples could include, for example, changing the plastic substrate with optics grade glass, quartz, or the like.

In another exemplary embodiment, and with a process similar to that of a laser printer, the media can be sensitized to laser light at the writer's frequency. Thus, the writing process causes the chemistry of the media to become reactive to, for example, a dye where the dye fixes to the media where it was exposed to the laser. For example, the media could comprise a substrate and a poly-sensitive chemistry. The writer, upon exposing an area of the poly-sensitive chemistry, creates one or more reactive portions in the photo-sensitive chemistry over which a dye is washed. The dye would then adhere to the area(s) where, for example, the laser exposed area(s) occur. A protective layer/edge sealant could then be applied to protect the media.

Another exemplary embodiment uses microcrystalline spheres. The spheres can be constructed from a multi-layer media where, for example, between two layers of a substrate, a layer of micro-spheres containing a dye or oxidizing chemical are placed. The optical properties of the micro-spears are such that they are transparent provided they are intact. However, upon exposure to a light source, such as a laser, the laser would cause the spheres to collapse spilling their contents into the localized area. The effected localized area could then be directly observed with a resolution corresponding to the area of the localized area. This could directly be observed or the contents could react with an inter-sphere medium and cause a localized chemical reaction that could also be observed.

Furthermore, ablation techniques can be used for writing to the media. Ablation techniques change the optical properties of the media by removal of, for example, a portion of the substrate. With the ablation techniques, a dye layer is not necessary. However, as with any technique that would remove a portion of the substrate, there should be a waste removal subsystem for removal of the “flakes” of media from, for example, the beam path of the writer. The waste removal subsystem could be based on, for example, a magnetic system, an air-based system, gravity based system, or the like, or some combination thereof as appropriate. Furthermore, the waste removal subsystem can depend on the type of media used.

The ablation technique can provide, for example, a uniform transmissive substrate where the media has a uniform density which is ablated to a depth corresponding to the density for the portion of the image (for a transmissive media). For example, a semi-transparent media is such that at its thickest it appears black and opaque, but at its thinnest is close to clear as illustrated in FIG. 11. In FIG. 11, the incident light beam 1110 is “dimmed” by the substrate resulting in a proportionally reduced brightness beam 1120.

Accordingly, depending on the depth of the ablation, multi-grayscale and/or color can be represented by the media, by, for example, combining it with appropriate color filter(s). Furthermore, the ablation depth could be controlled by modifying the power level of, for example, the laser writer, and/or controlling the size of the write area.

The ablation technique could also be used as a stamp or a press source where, for example, one or more deformations in the media corresponding to “pixel(s)” of the preservation mage are pressed or stamped into the media.

Alternatively, as illustrated in FIG. 12, in a reflective embodiment, a semi-transparent media at its thickest would be close to clear while at is thinnest appear close to black and opaque. Thus, a beam 1210 upon passing through the substrate and bouncing off the reflective layer 1230 would yield a reduced brightness beam 1220.

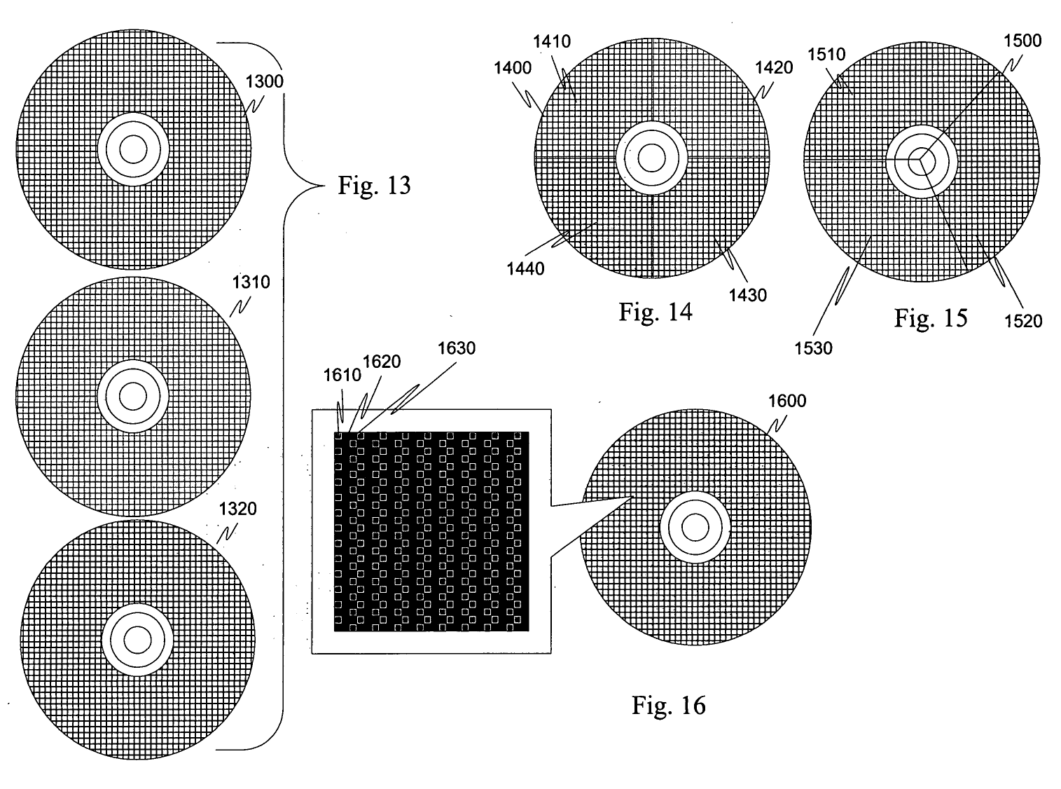

FIGS. 13-16 illustrate various exemplary embodiments for use with color content. It should be appreciated however that the color channels can be any combination of colors and are not limited to the combination and/or number disclosed herein.

FIG. 13 illustrates three-color separations performed on a per-disc basis. In particular, disc 1300 could be red, disc 1310 green and disc 1320 blue. This would allow multiple discs to be used to save and reconstruct the color content. An appropriate reader could then be used that, for example, sequentially reads each disc, or, for example, three readers simultaneously read the content on the three discs which are combined for reconstruction of the content.

FIG. 14 illustrates an exemplary four-color process, where the image segmentation occurs at 90° intervals. For any given image at a specific location a rotation of the disc through 90° in any other direction can provide another color channel of the image. Specifically, the media 1400 in FIG. 14 includes a first color channel 1410, a second color channel 1420, a third color channel 1430 and a forth color channel 1440.

FIG. 15 illustrates an exemplary three-color process media 1500. The media 1500 includes a first color channel 1510, a second color channel 1520 and a third color channel 1530. In this exemplary media, image segmentation occurs at 120° intervals such that for any given image at a specific location, a rotation of the disc through 120° in either direction will give another color channel of that same image.

FIG. 16 illustrates an exemplary embodiment of a preservation media 1600 where the color separation can be written sequentially to the disc with a locus of images occurring together. For example, the color separation can be accomplished with one image being constructed from a green channel 1610, blue channel 1620 and red channel 1630.

As will be appreciated from the following discussion of the various embodiments of the reader/writer associated with this invention, optical, digital and/or some combination of techniques can be used to recover the color image and can include various lenses and prism assembly's, storage device(s), and image digitizing modules as appropriate.

Furthermore, it should be appreciated that the laser strength of the writer could be modulated to produce continuous tone images. For example, with careful choices of media substrate used, the power level of the laser can be logarithmically associated to the optically visible deformation of any given location of the media. This is akin to using a paintbrush, a light stroke will result in a thin line, a heavy stroke a think line, however instead of producing a line, the process creates a pixel representative of the original source image data.

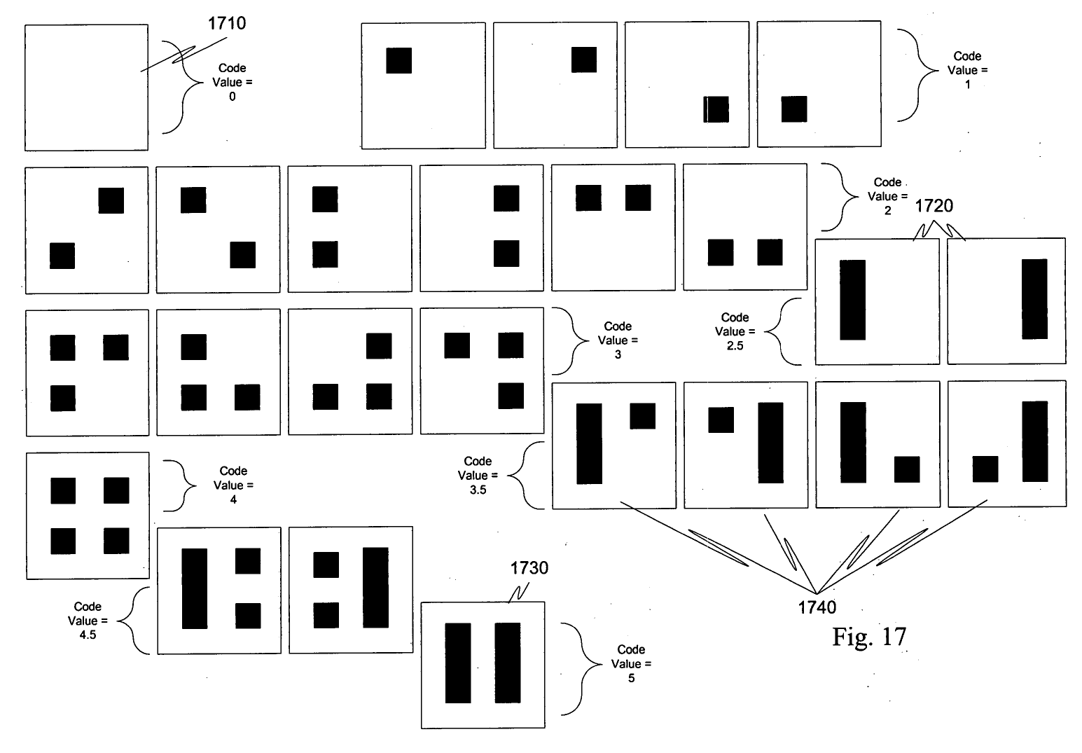

As illustrated in FIG. 17, dithering techniques could also be used to emulate grayscale and/or color values. This would allow, for example, the emulation of color or grayscale values without necessarily modulating the laser ablation or phase change dye. For example, in FIG. 17, progressive code values for image dithering are presented. The on/off pattern of dithering is representative of all the bit patterns compatible for representation of the image deconstruction in, for example, a two-by-two area of the surface of the media. The various blocks in FIG. 17 illustrate various code values such as code value 0 1710, code value 2.5 1720, code value 5 1730 and code value 3.5 1740. The dithering technique can be used as an extension to the technique of dithering to support the “swath writing” method, as discussed hereinafter, of the preservation system.

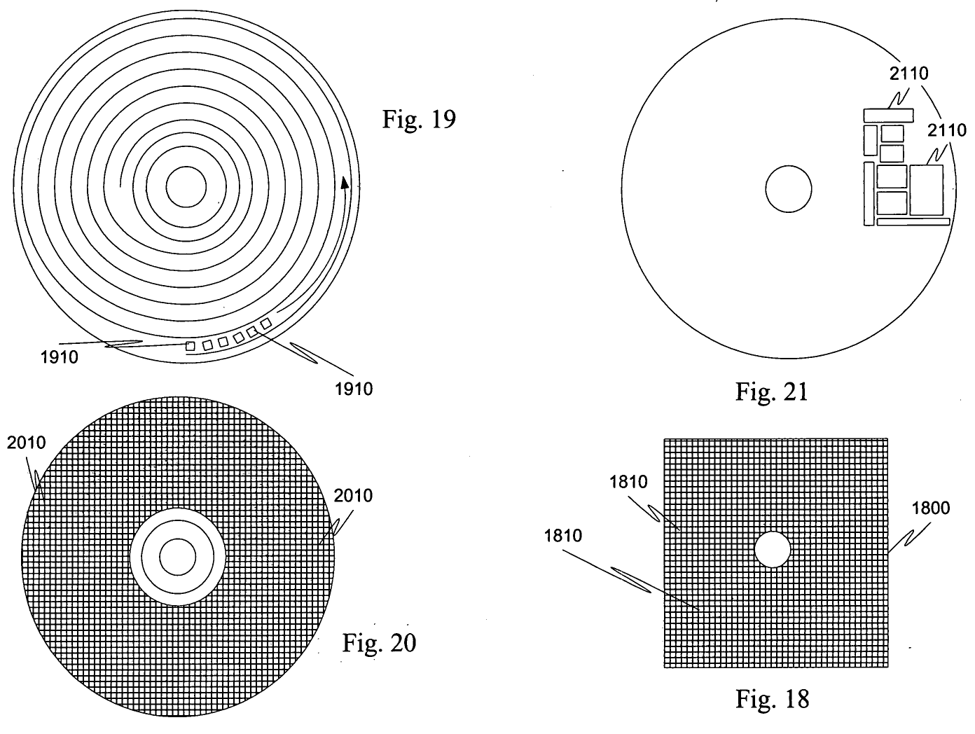

As illustrated in FIG. 18, it should also be appreciated that the media can be formed into any geometric shape including, but not limited to, a circle, square, octagon, hexagon, triangle, rectangle, cylinder, sphere, or the like.

As illustrated in FIGS. 9 and 10, a conglomeration of a larger number of media can be combined into, for example, a solid such that any individual media is able to rotate axially relative to another. An area of each media within the cylinder can be left unused, thereby being transparent, or there can be an actual physical “window” cut into the media. Thusly, by rotating the remaining media such that a clear window is visible all the way through the cylinder, rotation of any individual media piece results in being able to retrieve of preservation image(s) from an “internal” piece of media through the transparent areas. In another embodiment, the cylinder could be solid with successive layers of substrate/dye formed and hatched or burnt, recursively. This would allow, for example, in addition to standard preservation of content, the ability to generate a three-dimensional model and the immediate representative of, for example, a three-dimensional object. Also, a confocal microscope could be used to retrieve one or more images from any depth of the media.

More specifically, for spherical media, a sphere can be generated with, for example, multiple layers of phase change media and substrate interchanged. The sphere could be generated, for example, starting with a seed ball which is rotated and substrate, media, a write or burn technique, repeat . . . as applied to the seed ball thus forming the sphere. As with the other media described herein, the center point could be coterminous with an illumination device and could also be used to generate a 3-D image. Furthermore, a three-dimensional multivarient rectangular conversion to polar coordinate could be used thus allowing the writer to know what needs to be written on any given layer or location of the sphere.

As illustrated in FIGS. 19-21, various techniques and/or patterns can also be used in arranging the preservation images on the media. For example, as illustrated in FIG. 19, the preservation images 1910 are arranged in a spiral pattern on the media.

In FIG. 20, preservation images 2010 are arranged in a linear fashion and can be continuous and/or randomly dispersed on the media.

In FIG. 21, a space optimization technique could be applied such that preservation images of varying size/shape can be arranged to maximize utilization of the media.

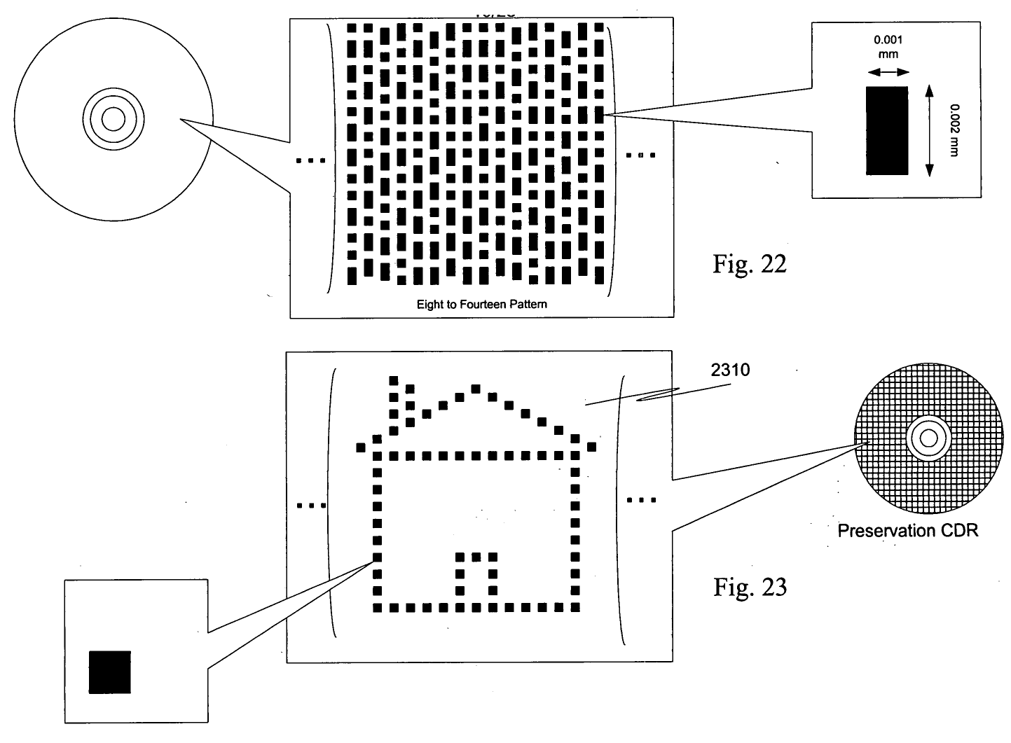

As illustrated in FIG. 22, compact disc technology uses an eight-to-fourteen pattern to write pits, representing ones or zeros, to a media. The pits are typically of length 0.001 mm to 0.002 mm and are burned into the media by a laser. This results in a pattern of created marks that are strictly regulated and have no apparent organization nor are capable of conveying information to the human eye.

As illustrated in FIG. 23 however, the preservation system writes areas to a media with the areas corresponding to, for example, one or more pixels of the preservation image 2310. These areas can be of any size, shape and, as discussed elsewhere, color or grayscale resulting in an image that is human readable. The size and shape of the areas are only limited by the capabilities of the writer and utilized media.

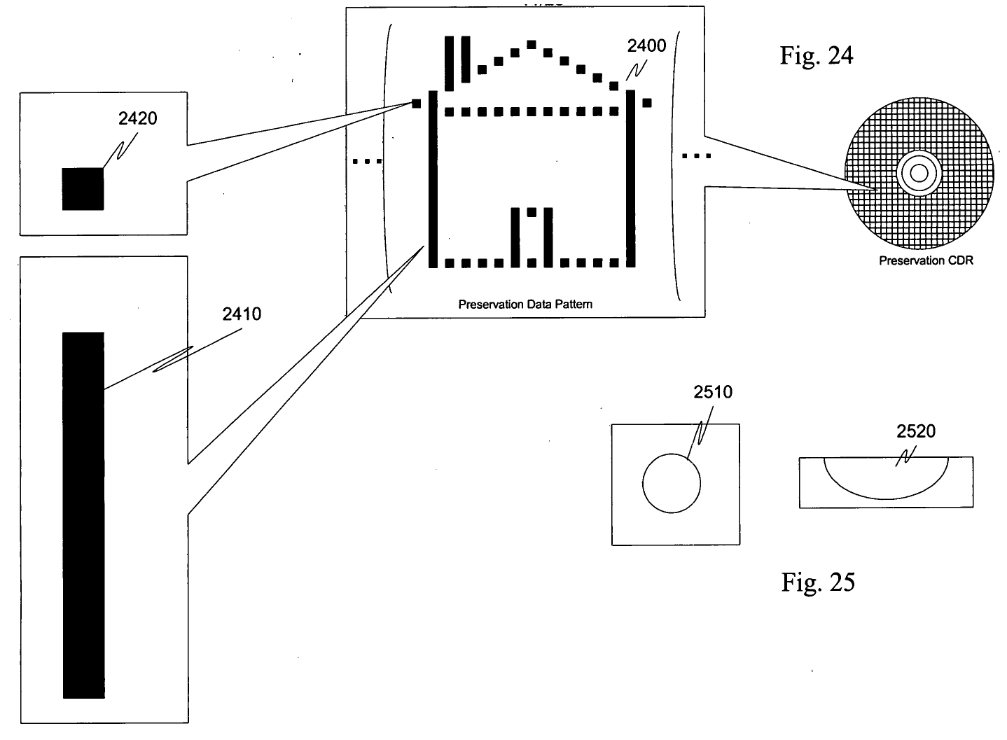

As illustrated in FIG. 24, the length of the portion 2410 can be extended as appropriate thus allowing “swath” writing. For example, as illustrated in portion 2410, a swath has been written that corresponds to the “walls” of the house, while portion 2420 is a short “swath,” such as a point, that represents an “eve” of the house. Thus, it should be appreciated that any complex or fundamental pattern of writing to the disc is possible with these patterns including, but not limited to, circular, rectangular, square, conical, triangular, “w” shaped, elliptical, or the like

As illustrated in FIG. 25, a pit can be formed, for example, as a circular bump 2510, as a cylindrical groove 2520, and/or an oval pattern, or the like. It should be noted that with specialized masking and filtering over the laser output stage any continuous pattern could be achieved. For example, if a triangle shaped stencil where placed in the beam path the pattern left in the grove could have a triangle shape for each pixel produced, if the stencil were static and unchanging the start and stop positions of the beam would have the characteristic of the stencil (of course any regular or irregular n-sided polygon or continuous curved shape could be uses to collimate the beam. If the stencil were not static, and either continuously deformable, or even rotatable, then the options for pixel shape and characteristic are more numerous. Preparation of the image source data at the primary stages of the system would include instructions for the control of the stencil and its operation during the writing process so as to achieve the desired effect. Furthermore, as illustrated in FIG. 24 these shapes can be extended such as to enable “swath” writing.

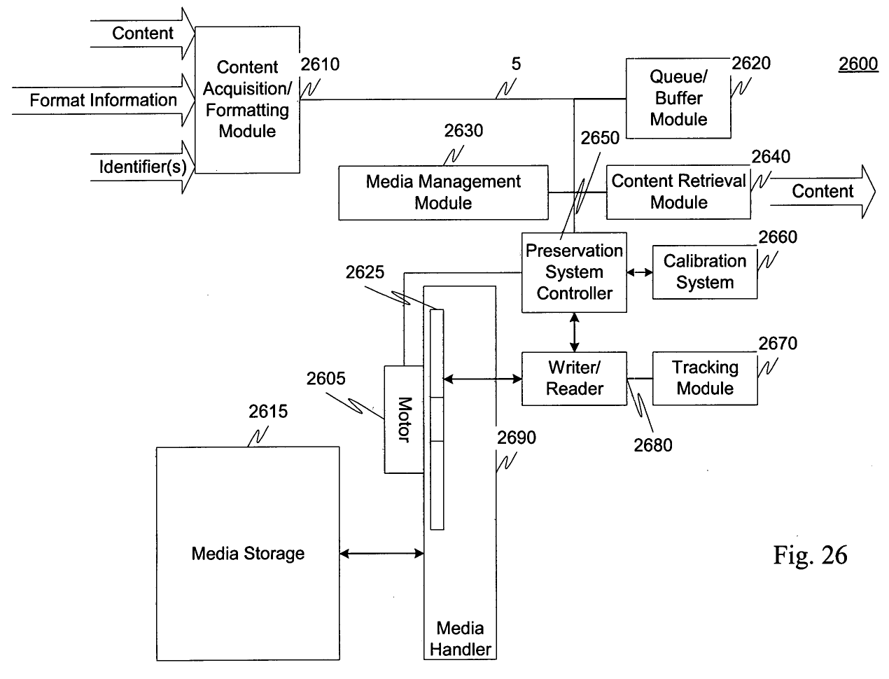

FIG. 26 illustrates an exemplary reader/writer 2600. The reader/writer 2600 comprises a content acquisition/formatting module 2610, a queue/buffer module 2620, a media management module 2630, content retrieval module 2640, a preservation system controller 2650, a calibration system 2660, a reader/writer 2680, a tracking module 2670, a media handler 2690, one or more media 2625, a motor 2605 and a media storage 2615. The various elements are connected via one or more links 5.

In operation, one or more of content, formatting information and identifiers are forwarded to the content acquisition/formatting module 2610. The content acquisition/formatting module 2610 receives the content and based on one or more of the format information and media to which the content will be written prepares the content for writing. For example, the format information can include information such as for a grayscale or color image how the image is to be separated and/or written, what type of media is to be used, or the like. The identifier(s) can include information associated with the content including, but not limited to, preservation image data, metadata, how many images to store per disc, and the like. Upon assembly of the incoming content into an organized format, and conversion of the incoming data from rectilinear information to polar information, and in cooperation with the queue/buffer module 2620, the preservation system controller 2650 and writer/reader 2680, the preservation images and associated information, if present, are written to the media 2625. The media 2625 can be inserted manually into the system or with the cooperation of the media handler 2690, and/or retrieved from media storage such as media storage 2615. The media storage 2615 can include, for example, a media jukebox, a media library, mechanical positioning systems an automated handler or robotic manipulators, or the like.

Thus, for example, if the media storage 2615 is a media library, the media management module 2630 can cooperate with the media handler 2690 to facilitate retrieval and replacement of one or more media 2625 from the media storage 2615. Furthermore, it should be appreciated that the writer/reader 2680 can cooperate with the tracking module 2670 depending on, for example, the format with which the preservation image is written to the media 2615 to ensure proper placement of the writing and/or reading head (not shown) relative to the media.

The calibration system 2660 allows calibration of the reader/writer 2680 such that image quality including color correctness, grayscale accuracy, resolution, focus, beam positioning, and the like, can be maintained. One such calibration technique would involve the writing of a linear deformation from the edge of the media to the center or from the center to the edge while the disk is stopped. The calibration mark thus produced would be read every 360 degrees to insure accurate positional data.

Once one or more preservation images are stored to the media 2625, the preservation image(s) and/or associated information can be retrieved in conjunction with the reader/writer 2680, preservation system controller 2650, content retrieval module 2640 and the media management module 2630, if appropriate. For example, the media 2625 could be retrieved from the media storage 2615 based on, for example, an identifier associated with the particular media as discussed hereinafter, with the reader/writer 2680 retrieving the one or more preservation image(s) and associated data and forwarding it to the content retrieval module 2640 that can be, for example, a display, a printer, or the like.

As illustrated in FIG. 1, calibration marks 50 can be used to, for example, control the timing and/or speed of the motor 2605, can aid with jitter correction, retrieval of a preservation image, and the like. For example, in a hybrid type of reader, an automated process could be utilized to locate the media and a preservation image thereon, such that the image is placed in the viewable area of a viewer that enables direct viewing by a user.

The calibration system 2660 can also have a dedicated calibration routine where, for example, various media are written to and/or read from and the accuracy of the information verified with one or more corresponding adjustments to the system made, if necessary.

In a first exemplary write process, media 2625 can be spun and the groove from the inner edge to the outer edge of the media followed with the writing of the polar data stream from the queue/buffer module 2620 to generate the preservation media. In a second embodiment, the media 2625 can be started and stopped with the cooperation of motor 2605 and the preservation system controller 2650 with the heads of the reader/writer 2680 moved from the center to the edge or the edge to the center while controlling the writer, such as a laser. The media 2625 is then rotated forward one unit and the process repeated, for example, for the entire 360° of the media.

In a third embodiment, the media 2625 is spun in a reverse direction while moving the head of the writer/reader 2680 from the center to the edge or the edge to the center of the media. In this embodiment, the writer 2680 is skipping across the lands and valleys with the swath being created in a spiral shape, but the pixels formed on a bias-end up canceling out the spiral of the media's groves thereby creating a square grid of preservation images.

In a fourth exemplary embodiment, the motor 2605 in cooperation with the preservation system controller 2650 and the reader/writer 2680, jogs the media 2625 in a back-and-forth manner while at the same time manipulating the head of the writer 2680 to write, for example, preservation image(s) to the media.

In yet another embodiment, the media could be held static while the writing/reading head moved.

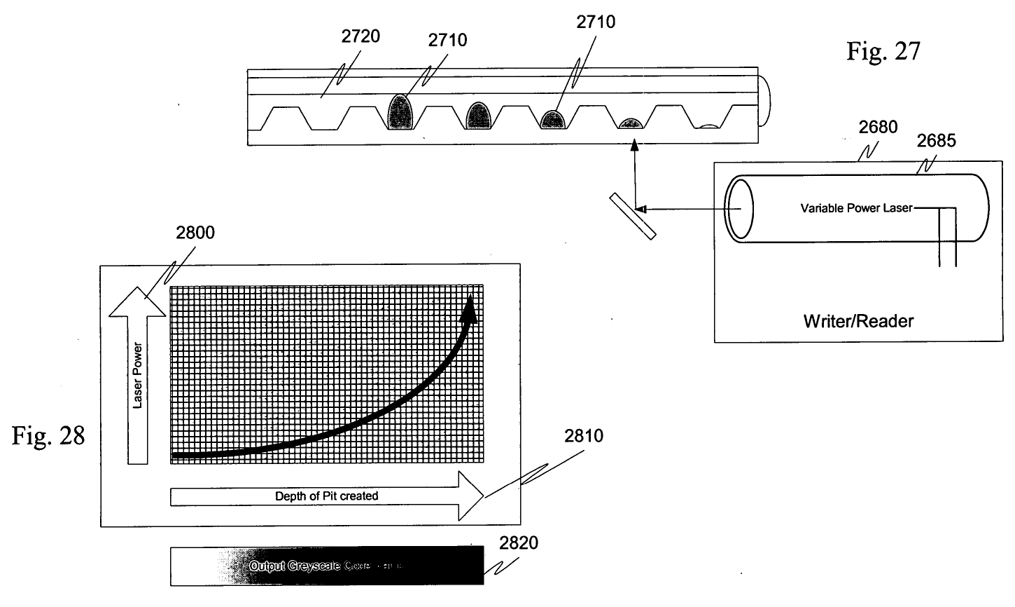

FIG. 27 illustrates the ability of the writer/reader 2680 to use, for example, a variable laser power to change the depth of the “pit” that is produced. As illustrated in FIG. 27, various pit depths 2710 are illustrated within the phase change dye layer 2720.

For example, writer 2680, which can include a variable power laser 2685, can ablate to different levels of depth in, for example, a phase change media. This can then be read back by, for example, a special reader such that, for example, a grayscale or color level for each code value of laser power input, or alternatively, reflected light differences, can be perceived by a human eye. FIG. 28 shows the correlation between the laser power 2800, pit depth 2810, and output grayscale/color code value 2820. Thus, it is apparent that in accordance with increased laser power and pit depth, the code value also increases. However, it should be appreciated, that the relationship in FIG. 28 could be reversed based on the type of media that is used.

The areas defined as valleys or groves where the laser is placing the image data, are principally defined as the image locations, however the area interstitial to adjacent groves in a single locus is defined as a “land.” Such lands may also be used as loci for placement of image data. In other words, the embodiment intends to place image data not only in the image area of the media but also in the areas not traditionally used. As discussed, this aids in alleviating the “Venetian blinds” imaging artifacts possible with traditional optical media.

In addition to the power modulation technique discussed above, grayscale control can also be accomplished by dithering and re-writing. With dithering, code values can be produced as discussed above in relation to FIG. 17. In addition, combination of effects with the “swath writing” technique across a 2×2, 4×4, or N×N pixel area (kernel) can be utilized. This would allow, for example, an additional 1.5 code values per kernel area.

With re-writing, a region can be re-written to one or more times thereby increasing its contrast ratio and expanding dynamic range.

With swath writing, pits of different lengths are placed apart from one another. This basic concept can be expanded to include writing a pit of any length and/or width, with or without a fixed “gap” between the pits thereby allowing the gap to be of any length, including zero. Furthermore, with grooved media, the reader/writer 2680 is able to write to the valley, the land, or both. Thus, for example, by writing to the lands, the Venetian blind affect of the output image can be reduced.

The reader, in its most basic form, is a human reading a preservation image from the media directly, or with the aid of a simple magnifier, microscope, or the like.

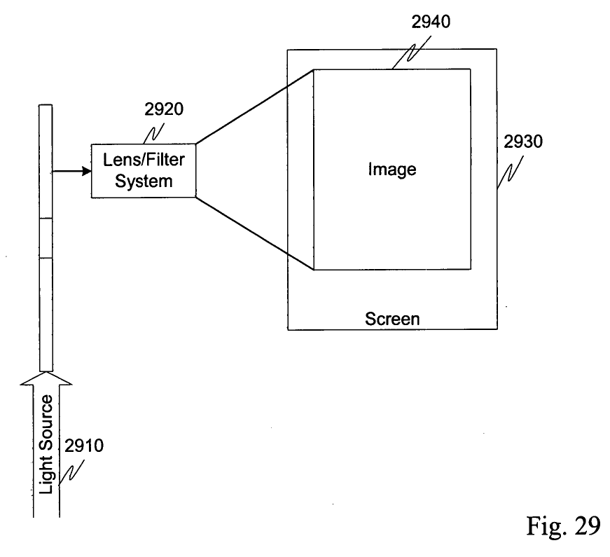

FIG. 29 illustrates a first exemplary reader having an edge based light source 2910 which illuminates one or more preservation images within the media, the illuminated preservation image being collected by the lens/filter system 2920 and the resulting displayed image 2940 corresponding to the preservation image displayed on the screen 2930. The screen 2930 can be, for example, a projector screen, a wall, a dedicated reader, or the like.

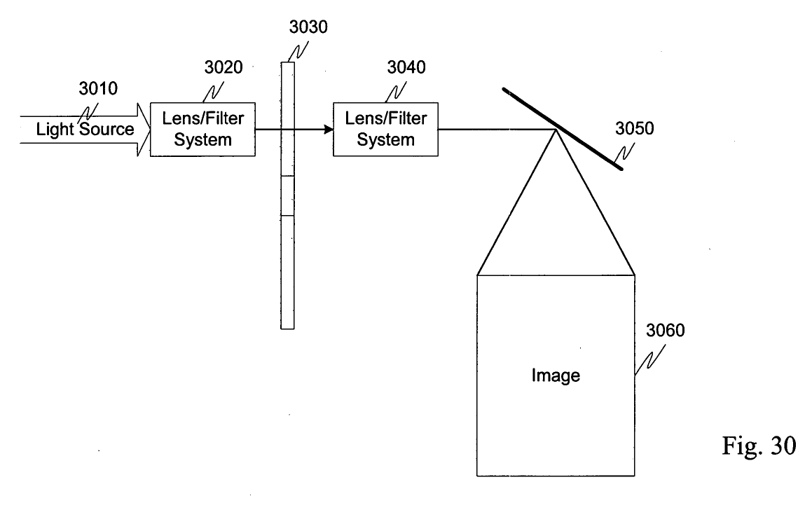

FIG. 30 illustrates another embodiment of a transmissive light source based reader. In particular, a light source 3010 passes through a lens/filter 3020 and illuminates one or more preservation images within the media 3030. The lens/filter system 3040 receives the display image corresponding to the preservation image and, after being reflected by one or more optional mirrors 3050, is displayed as image 3060 on, for example, a screen, within a dedicated reader, on a wall, or the like, as previously discussed.

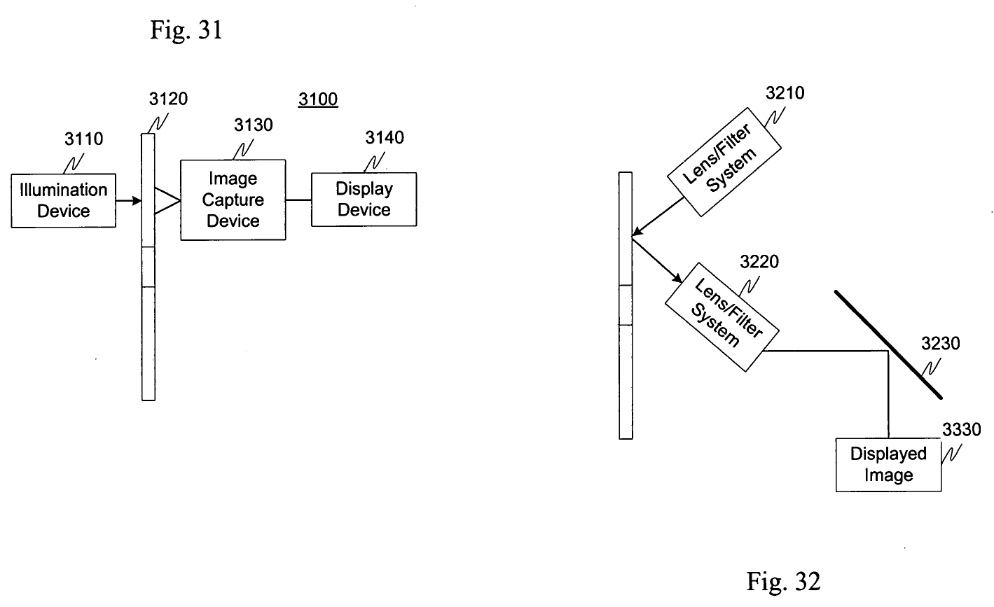

FIG. 31 illustrates a hybrid reader 3100. The hybrid reader 3100 comprises an illumination device 3110, an image capture device 3130 and a display device 3140. The illumination device 3110 illuminates one or more preservation images within the media 3120. The image capture device 3130, such as a CCD, photodiode array, laser scanner, or the like, captures and digitizes the corresponding image. Furthermore, the image capture device 3130 can read one or more portions of digital data associated with the preservation image, all or a portion of which can be displayed in conjunction with the preservation image on the display device 3140 which can be, for example, a computer display, a projector, a dedicated reader display device, or the like. Furthermore, the hybrid reader 3100 can include, for example, an analog to digital converter thereby allowing the resultant image corresponding to the preservation image converted into digital form, such as a digital image, or the like, which can then, for example, be digitally distributed and displayed and/or printed on one or more devices as appropriate.

FIG. 32 illustrates another exemplary embodiment of a reader system that, instead of utilizing light passing through the media, utilizes reflected light from lens/filter system 3210 which is then collected by the lens/filter system 3220, reflected by one or more optional mirrors 3230, with the resulting display image 3330 displayed on, for example, a display device as previously discussed.

It should be appreciated, that the various image capture devices and display devices discussed herein can be used interchangeably with any of the disclosed readers.

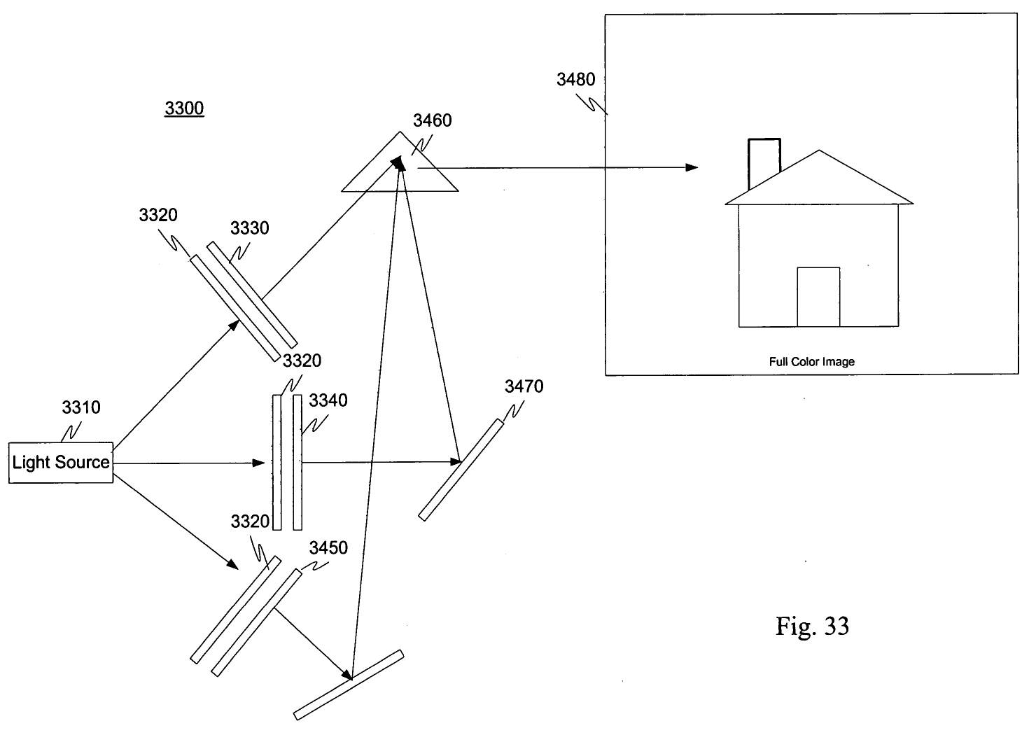

FIG. 33 illustrates an exemplary reader that can be used, for example, with variable bit depth and/or color filters to enable the reproduction of a full color image. In particular, the reader 3300 comprises light source 3310, one or more filters 3320, a red preservation media 3330, a blue preservation media 3340 and a green preservation media 3450. The light source 3310, passing through the filters 3320, illuminates a preservation image on the various media which are combined, via the prism 3460, and displayed as full color image 3480. It should be appreciated, that while the reader 3300 operates in a parallel, optically based configuration, image capture devices and memory could be incorporated in the system thereby allowing, for example, elimination of the prism and mirrors, and serial reading of the three color preservation media with subsequent electronic combination of the preservation images. Furthermore, while red, blue and green preservation media are described, it should be appreciated that the color channels can be broken up into any combination of colors as appropriate. Likewise, the media need not themselves be color specific, the media can include information specifying, for example, which color channel they correspond to and/or color filters used which correspond to the one or more color channels. Furthermore, based on color channel information associated with the media, the color information could be electronically added to the read image, for example through image processing software, to facilitate color image retrieval. The full color image 3480 can then be displayed directly, for example, on a screen, or via a display device, such as a computer monitor as previously discussed.

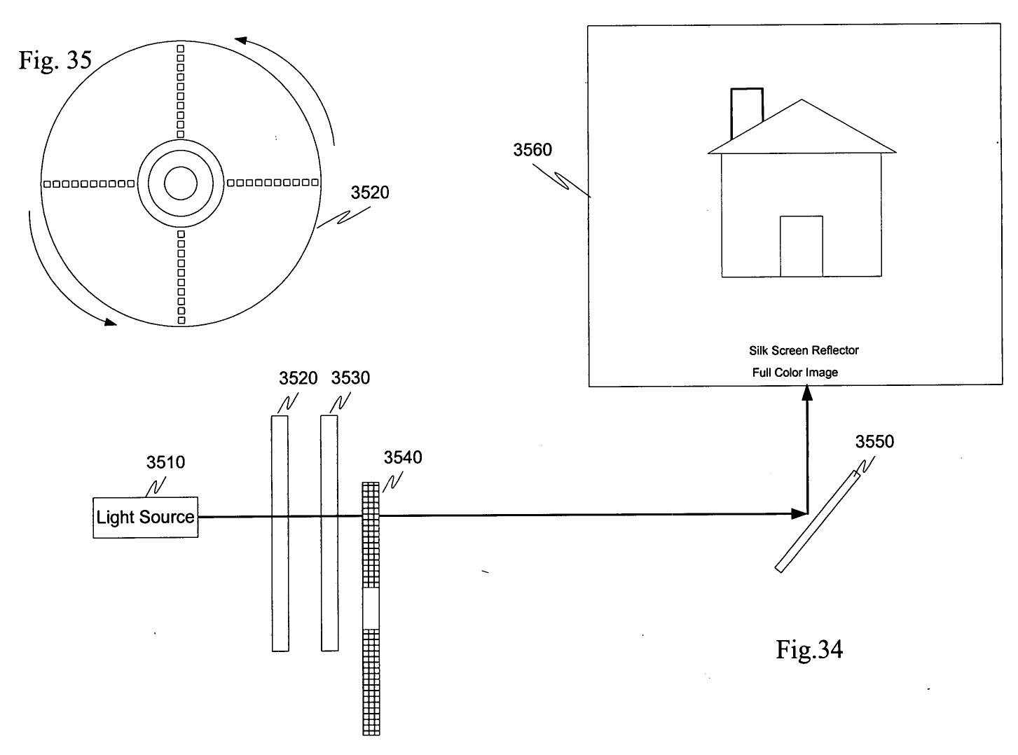

FIG. 34 illustrates an exemplary system that can be used to read preserved animation and/or motion sequences, such as motion video. In its most basic form, as illustrated in FIG. 35, a light source 3510, passing through a first filter disc 3520 and a second filter disc 3530, also passes through the preservation media 3540 with the resulting preservation image(s) reflected on mirror 3550 and displayed, for example, on screen 3560 it should be appreciated that with preserved animation or motion video content the content needs to be read in a particular sequence to preserve continuity. This sequencing information, e.g., instructions, could be stored on the disk and/or a predetermined sequence followed. FIG. 34 illustrates in greater detail the first filter disc 3520 that, for example, spins in an opposite direction to the second filter disc 3530. Thus, a combination of these two filter discs spinning in opposite direction enables the recreation of a motion image when combined with a spinning media 3540 stencil that contains a continuously sliding window. Thereby, for example, a three-color process could be emulated with a gelatin film in between each layer. Alternatively, each layer could have an integral layer containing the filter or the filter could be composite within the phase change dye itself.

In addition, various other types of readers that work either in serial or parallel can be utilized based on, for example, the type of media(s) that are used for preservation of the content. For example, two or more preservation disc can be superimposed, with each disc having only a portion of the preservation image, thus the combination of the discs would reveal the entirety the preservation image. Obviously, the reconstruction of the image can be done by physically placing one disc on top of another and, for example, aligning the two discs with calibration marks. Alternatively, the first portion of the image could be read off of the first disc, the second portion of the image read of the second disc, and the appropriate image processing hardware and/or software utilized to combine the portions of the image into the reconstructed preservation image. As will be appreciated, this may involve an analog to digital converter, image capture device, image processing software and/or storage for storing the two portions of the preservation image.

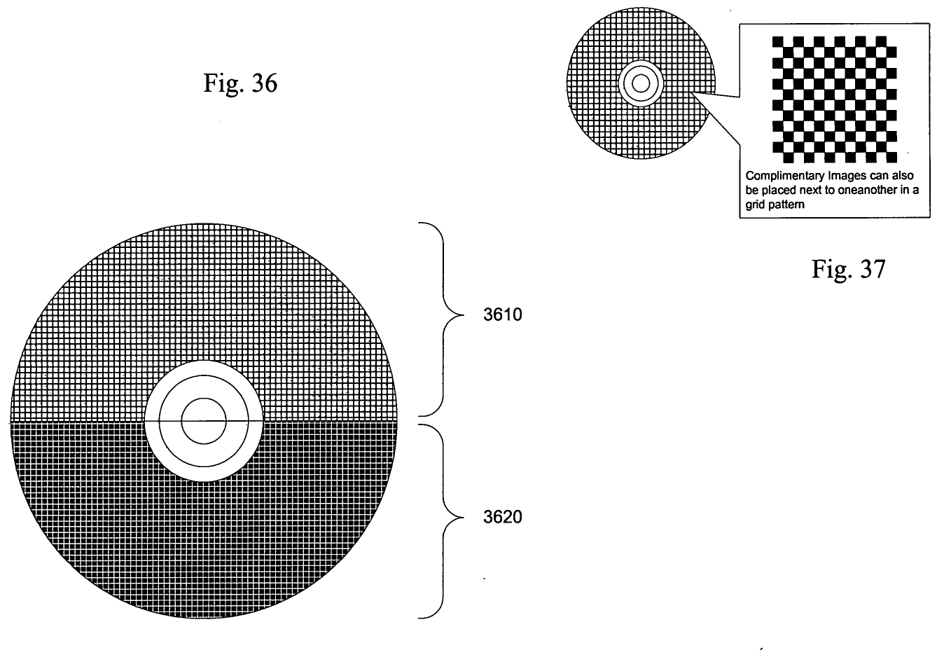

As illustrated in FIG. 36, and utilizing the combination of a positive and a negative of the stored content, a tamper resistant media can be produced. For example, as illustrated in FIG. 36, a positive portion 3610 contains one or more preservation images, with their corresponding negative counterparts stored in portion 3620. While in this exemplary embodiment, the positive and negative images are separated on two halves of the preservation media, it is to be appreciated, as illustrated in FIG. 37, that the complimentary images can also be placed next to one another, for example, in a grid pattern or separated onto different discs. Thus, by writing both the positive and the negative image to the media, the media can be protected from additions and deletions as previously discussed. Therefore, any tampering would be evident in that one image would not be the inverse of the corresponding negative image.

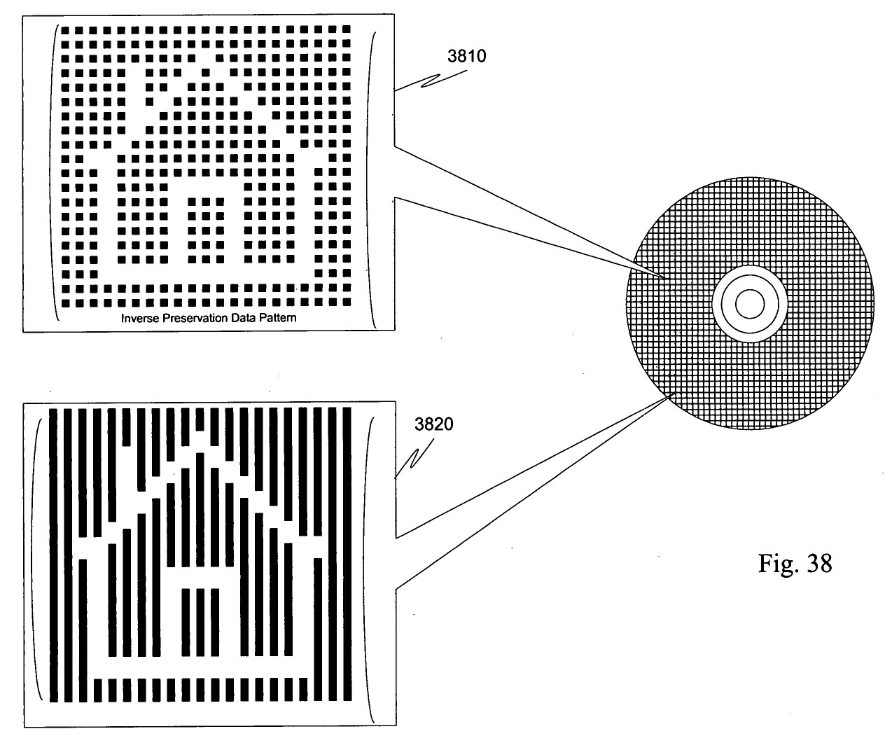

This can be further illustrated with the aid of FIG. 38 that shows two exemplary versions of inverse data pattern writing. In a first exemplary embodiment, the inverse data pattern is written, for example, with a dot-like structure 3810. Inverse data pattern 3820 illustrates an inverse preservation data pattern utilizing a swath/groove writing technique that could also be used. However, in general, it should be appreciated that any type of inverse data patterning can be utilized to create an inverse of a preservation image in accordance with the embodiments discussed herein.

In addition to the various types of media, readers and writers discussed above, data informatics could also be associated with the various aspects of this invention. For example, hybrid media could be utilized that employs, for example, both the conventional ISO 9660 data, and/or other digital data, as well as preservation images. This could allow, for example, reading and recovery software, digital information, or any information associated with one or more of the preservation images to be collocated on the preservation media. For example, digital information can be stored in a first portion of the disc, with the preservation images on another portion of the disc. Then, for example, using a hybrid reader that is both capable of reading the digital information as well as the preservation images, both types of information could be recovered from the media. For example, the software embedded on the hybrid media could include firmware updates that allow the reconfiguration of conventional media drives thus providing them with the ability to read preservation images stored on the media.

Methods of executing the write process can also include information processing algorithms to prepare the image data stream to support the writing process with constant aural velocity or constant linear velocity, where constant aural velocity is defined as the revolutions per minute of the disk at any time being constant with respect to the disk, while constant linear velocity is defined as the revolutions per minute of the disk is continuously variable with respect to the position of the writing head such that the speed of the media under the head is held constant.

Furthermore, the basic techniques described herein can be expanded to include four-dimensional data such as video and motion film. For example, animation or motion video could be preserved by, for example, sequentially storing each image on a media. Alternatively, spherical media could utilize successive layers with each layer representing time-lapse information. Thus, for example, a first sphere could contain a low-resolution initial portion, with detail and resolution increasing over time, with additional layers being placed on the media thereby resulting in, for example, a final product that could be visible at any time as well as a complete history of the preserved subject.

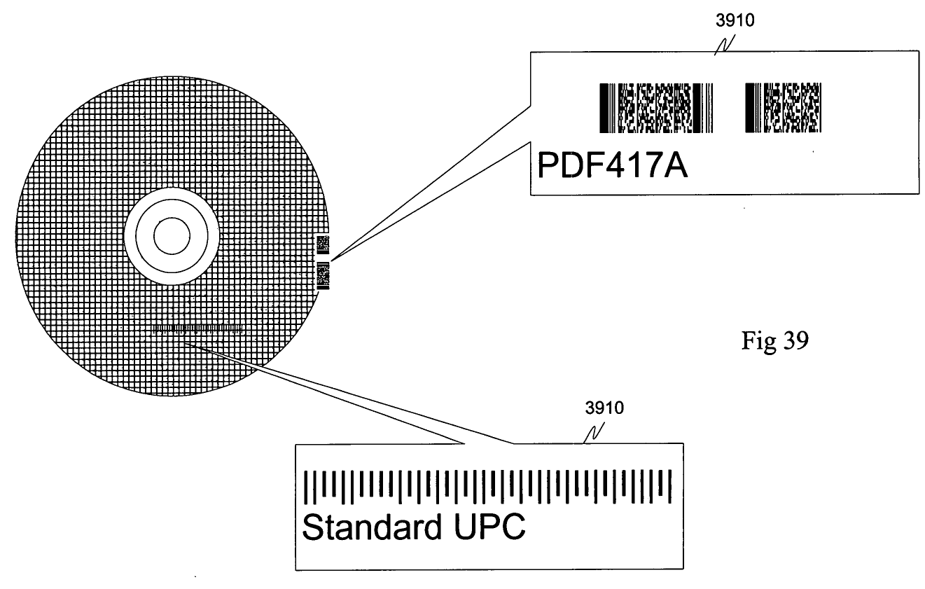

Additionally, the media can include various information such as a table of contents, x-y location information of one or more preservation images on the media, disc and/or volume information, archival date information, writer information, or the like. These various types of information can be stored in a digital or analog format, for example, in conjunction with a hybrid disc embodiment disclosed above and/or could be, for example, stored on a bar code located on either the surface or the edge of the media as illustrated in FIG. 39.

These barcodes 3910 could include information such as, but not limited to, a catalog of the preservation images stored on the disc, disc volume information, metadata information about the disc, serial numbers, unique identifiers, version numbers of the preservation media system used to create the disk, and the like. Furthermore, to facilitate retrieval of the media in a jukebox-arrangement, an identifier, such as a barcode, could be placed on the spine of the media that could be read by a supplemental device (not shown) that would allow the selection of the media from the jukebox and subsequent placement of the media into, for example, the media handler 3690.

Furthermore, encryption techniques can be used with the various media disclosed herein. For example, an original source image can be spit based on a primary random noise mask pixel by pixel randomly into M number of media in, for example, positive format, and exclusive OR'd with a random pixel mask, the M number of media corresponding to the level of required security. The M media are then written. To recover the original image, the mask negative is composited using XOR again to combine the M discs.

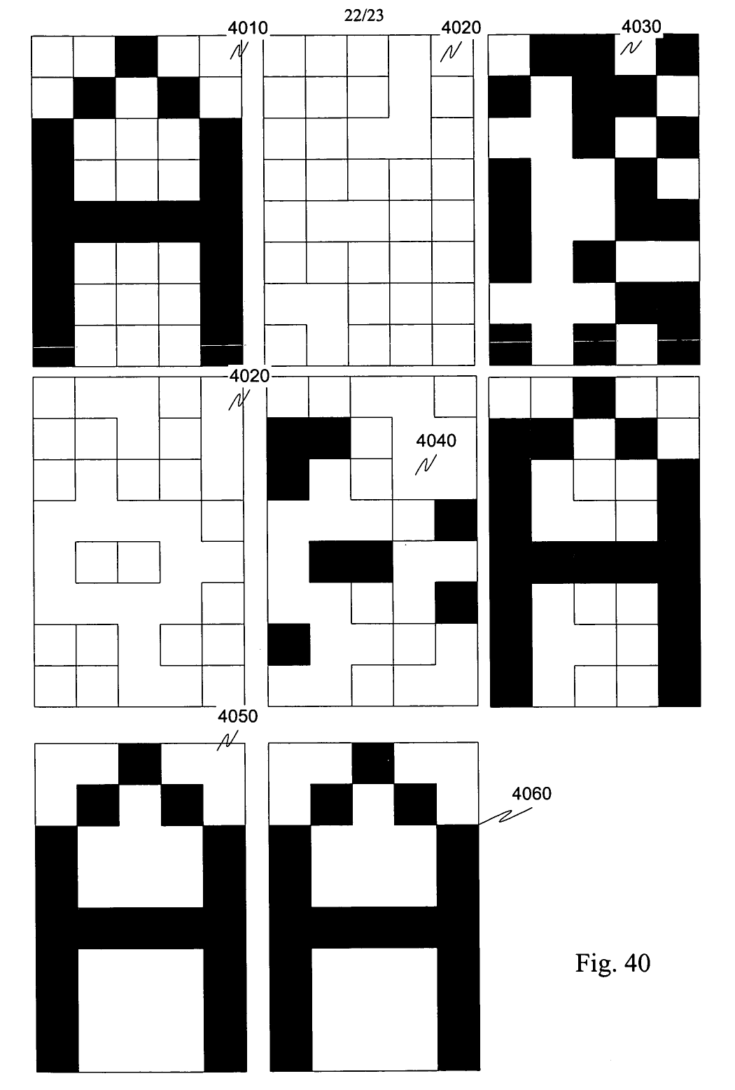

For example, as illustrated in FIG. 40, an original image 4010, is exclusive OR'd with a predetermined number of random pixel masks 4020. A corresponding number of encrypted media 4330 and 4340 are thus produced that are based on the corresponding random mask.

To recover the original image, the mask negative is composited using XOR revealing the composited image 4050. From this, the original image 4060 can then be recovered.

Additional information such as serial numbers, the number of images, or the like, could facilitate data integrity indicating, for example, the total number of images on the disc, or the like.

Furthermore, indexing and keyword searching can be used in conjunction with the various media discussed herein. For example, the metadata could be stored in a digital portion of the media to facilitate faster retrieval and indexing. This metadata, and associated index, could be combined with one or more additional metadata and indices from one or more other media such that multiple media could be searched simultaneously for, for example, an image with a particular keyword or keyword string. The results could then be cross-indexed to allow locating the one or more media(s) associated with the keyword and associated preservation image.

For example, a miniaturized version of a “title page” could be stored on the media along with, for example, a topic map and indices of the preservation images stored on the media. As previously discussed, this topic map could be written at the edge of the media, for example, in a barcode format, as previously discussed, wherein the edge could be coplanar with the preservation images or orthogonal to the preservation images, where it is written in the outermost track of the media. For example, a “one page” title page could be written on the edge of each media, with a multi-layer media capable of having a number of pages, with a page corresponding to each layer of the multi-layer media.

Furthermore, aperture windows with iconographic demarcation could be used for indexing data. An index page with unique icons can be utilized representing each document in the collection. These unique icons can be embodied in a bit pattern that represents a “key” to the actual data on the disk. As the key is able to represent within a statistical margin of error the actual image data, the key can be electronically compared to all subsequent images on the disc. When a pattern match occurs, the next sequential image is the document/image represented for the index. This is akin to a page numbering scheme, however there are never any repeated numbers as the “key image” is guaranteed to be unique.

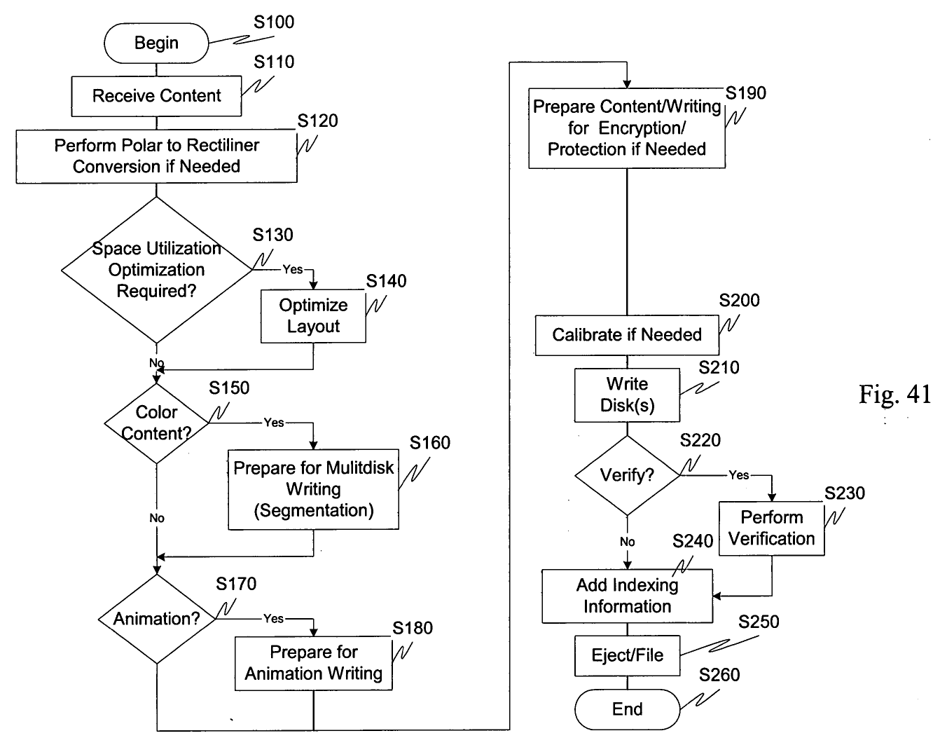

FIG. 41 illustrates and exemplary method of creating and preservation media according to this invention. In particular, control begins in step S100 and continues to step S110. In step S110 content is received. Next, in step S120, a rectilinear to polar conversion is performed. The rectilinear to polar conversion technique can be an image processing technique and associated algorithms that create an image data stream while compensating for the polar nature of writing process, including the ability to compensate for one or more of the spiral nature of media and the concentric circle nature of the writing process.

Then, in step S130, a determination is made whether space utilization optimization is required. If optimization is required, control continues to step S140 where the layout is optimized. Otherwise, control jumps to step S150.

In step S150, a determination is made whether the received content is in color. If the received content is not in color, control jumps to step S170. Otherwise, control continues to step S160 where the system is prepared for color writing including, for example, multi-disc writing, segmentation, or the like. Control then continues to step S170.

In step S170, a determination is made whether animation is present in the received content. If animation is not present, control jumps to step S190. Otherwise, control continues to step S180. In step S180, the system is prepared for animation/motion video writing and the appropriate combination of disc and/or filter prepared. Control then continues to step S190.

In step S190, the content is buffered and, if encryption or protection is needed, the processing/disc utilization determined and performed. Control then continues to step S200.

In step S200, calibration, if needed, is performed. Next, in step S210, the content is written to the one or more discs. Then, in step S220, a determination is made whether to verify the written content. If verification is needed, control continues to step S230 where verification is performed. If verification fails, notification of such can be indicated with, for example, a message to retry the writing process. Otherwise, control jumps to step S240.

In step S240, indexing information and/or volume and/or disc information, which can be either analog, optical, magnetic, and/or digital in nature, can be written to the media. Next, in step S250, the media(s) is ejected and control continues to step S260 where the control sequence ends.

The above-described systems and methods can be implemented on a computer, server, personal computer, in a distributed processing environment, or the like, or on a separate programmed general purpose computer having the disclosed reader/writer capabilities. Additionally, the systems and methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, or the like, or a neural network and/or through the use of fuzzy logic. In general, any device capable of implementing a state machine that is in turn capable of implementing the flowcharts illustrated herein can be used to implement the invention. Moreover, the invention is not limited to CD's, CD-R's, DVD's, multi-layer DVD's, blue ray DVD's, write once media, rewritable media, MD's, DVDR's, and DVDRW's, but rather, and in general, can be applied to any current or future developed optical, opto-magnetic or in general any media adapted to store preservation images.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and data processing arts.

Moreover, the disclosed methods may be readily implemented in software executed on programmed general purpose computer, a special purpose computer, a microprocessor, or the like. Thus, the systems and methods of this invention can be implemented as program embedded on personal computer such as JAVA® or CGI script, as a resource residing on a server or graphics workstation, as a routine embedded in a preservation system, or the like. The system can also be implemented by physically incorporating the system and method into a software and/or hardware system, such as the hardware and software system of a personal computer and/or media reader and/or writer.

It is, therefore, apparent that there has been provided, in accordance with the present invention, systems and methods for preserving content. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A information storage media comprising:
a photosensitive writable optical substrate having deformations representing one or more pixels, the one or more pixels representing a portion of an image.

2. The media of claim 1, further comprising multiple layers including a phase change dye layer and a reflective layer.

3. The media of claim 1, further comprising multiple layers including a phase change dye layer and a substrate.

4. The media of claim 1, further comprising an edge sealant.

5. The media of claim 1, wherein information stored on the media has undergone a rectilinear to polar transformation.

6. The media of claim 1, wherein a plurality of media can be stacked together.

7. The media of claim 1, wherein the image is a graphical representation of original content.

8. The media of claim 1, wherein the media is one of transmissive or reflective.

9. The media of claim 1, further comprising one or more colored portions, the colored portions being combinable to reproduce a color image.

10. The media of claim 1, wherein a plurality of media are utilized, with different media representing different color channels.

11. The media of claim 1, further comprising utilizing dithering to represent one or more of grayscale or color values.

12. The media of claim 1, wherein the images are arranged on the media in one or more of a spiral pattern, a grid pattern, randomly and a space optimized pattern.

13. The media of claim 1, wherein a pit depth corresponds to a grayscale value.

14. The media of claim 1, wherein a positive and a negative of the image are created, the overlaying of the positive and the negative image revealing alterations.

15. The media of claim 1, further comprising at least one random noise mask and at least one inverse random noise mask that are used to generate a plurality of encrypted and inverse encrypted images, respectively, and a composite XOR'd image, representative of the image.

16. The media of claim 1, wherein one or more of ablation, crystallographic phase change, chemical sensitization, optical bleaching and thermally sensitivity are used to create the deformations.

17. The media of claim 1, wherein the media is circular, square, cylindrical, spherical or multi-angle.

18. The media of claim 1, further comprising an identifier associated with the media.

19. The media of claim 1, further comprising metadata associated with the image.

20. The media of claim 1, wherein the metadata is searchable.

21. A preservation media comprising:
a photosensitive writable optical substrate having contrasting portions corresponding to a grayscale or color value of one or more pixels, the one or more pixels representing a portion of original content.

22. A preservation media comprising:
information representing one or more pixels, the one or more pixels representing a portion of original content, the information written to the media based on a polar data stream.

23. A preservation media comprising:
a laser writable optical substrate having pits representing one or more pixels, the one or more pixels representing a portion of original content.

24. A method of writing information to a media comprising:
converting rectilinear information corresponding to one or more images representing content to a polar data stream; and
writing the polar data stream to the media so as to create graphical representations of the one or more images.

25. The method of claim 24, further comprising one or more of ablating, performing a crystallographic phase change, a chemical sensitization, an optical bleaching and a thermal alteration to deform the media.

26. The method of claim 24, further comprising reading the media of claim 24 to recover the one or more images.

27. The method of claim 24, further comprising separating the polar data stream into a plurality of color channels.

28. The method of claim 24, further comprising utilizing positive and negative images to secure the one or more images.

29. The method of claim 24, further comprising encoding the polar data stream onto a plurality of media.

30. The method of claim 29, wherein the encoding utilizes normal and inverse random noise masks.

31. The method of claim 24, further comprising marking the media with identifying information.

32. The method of claim 24, further comprising associating metadata with the graphical representations.

33. The method of claim 24, further comprising creating a variable depth pit, the depth of the pit corresponding to a grayscale value.

34. A method of reading a media comprising:
illuminating one or more images stored on the media, the images stored on the media based on a rectilinear to polar conversion process; and
displaying the one or more images.

35. The method of claim 34, further comprising retrieving the media based on identifying information.

36. The method of claim 34, further comprising combining a plurality of the images, each image corresponding to a specific color channel, to reproduce a color image.

37. The method of claim 34, further comprising reading a pit depth and correlating the pit depth to a grayscale value.

38. The method of claim 34, further comprising composite XORing a plurality of encoded images to reconstruct an encrypted image.

39. The method of claim 34, further comprising reading a dithering scheme to reveal color or grayscale information.

40. The method of claim 34, further comprising converting the one or more images to a digital file format.
